(19) United States
(12) Patent Application Publication
(10) Pub. No.: US 2009/0150208 A1
(43) Pub. Date: Jun. 11, 2009

(54) METHOD AND APPARATUS FOR INTEGRATED INVENTORY AND PLANNING

(76) Inventors: James Rhodes, Las Vegas, NV (US); Hansoo Kwan, Suwanee, GA (US)

Correspondence Address: K&L Gates LLP, P.O. BOX 1135, CHICAGO, IL, 60690, US

(21) Appl. No.: 12/024,596

(22) Filed: Feb. 1, 2008

Related U.S. Application Data
(60) Provisional application No. 60/887,696, filed on Feb. 1, 2007.

(51) Int. Cl. G06Q 10/00; G06F 15/18; G06N 3/08

(52) U.S. Cl. 705/9; 705/28; 705/29; 706/12; 706/21; 705/10

(57) ABSTRACT

An integrated inventory and planning system for a factory system, which builds large buildings for transportation substantially intact from one or more construction sites to building sites, is presented. The system can include a demand calculation unit, a requirements calculation unit and a scheduling unit configured to provide a schedule of operation for a factory system producing large buildings for transportation to a substantially permanent building site, wherein the schedule is based at least in part on a first calculation of the demand calculation unit and a second calculation of the requirements calculation unit.

### RELATED APPLICATIONS

This application claims priority to U.S. Provisional Patent Application No. 60/887,696, entitled “METHOD AND APPARATUS FOR INTEGRATED INVENTORY AND PLANNING” and filed on Feb. 1, 2007, the entire contents of which is hereby incorporated by reference.

### BACKGROUND

To build one or more homes, it is necessary to arrange for the appropriate materials to be at the appropriate location with the appropriate construction workers at the appropriate time. In large scale development constructions, inefficiencies in controlling the flow of materials and workers can result in excess inventories of certain materials (resulting in potentially higher storage and/or financing costs) or shortages of materials (resulting in construction delays and higher costs). As a result, an efficient inventory system is desirable.

### SUMMARY

An integrated inventory and planning system for a factory system, which builds large buildings for transportation substantially intact from one or more construction sites to building sites, is presented in accordance with one or more embodiments. In one embodiment, the system develops and/or maintains a master production schedule based at least in part by any one or more of present, historical and/or projected customer orders/purchases, present, historical and/or projected inventory of raw materials, components and/or complete and/or partly complete buildings, historical, present and/or projected lead times for materials orders, available order quantities, historical, present and/or projected manufacturing requirements (e.g., resources, time, workers, etc.) for complete buildings and/or portions of buildings, historical, present and/or projected building moving equipment availability, historical, present and/or projected prepared building site inventory, historical, present or projected factory system maintenance requirements, or any other suitable data. Preferably, the master production schedule includes one or more periods (e.g., annually, quarterly, monthly, weekly, daily, hourly, or any other suitable time period) during which one or more events or actions (e.g., materials ordering, component or entire building manufacturing, equipment movement, site preparation, or any other suitable event or action) takes place.

Preferably, a bill of materials (BOM) is prepared for each type of building. Alternatively, a BOM can be prepared for each building. A BOM for an item is a list of the components and quantities used to manufacture that item. Preferably, BOMs are also prepared for each of the components listed in the BOM for the building; however, BOMs are not required for each component listed. Further, BOMs are preferably recursively prepared for components listed in other BOMs until only raw materials are listed; however, BOM generation may end at a specified level before reaching raw materials under the assumption that components and/or raw materials beneath that level are available on demand, or BOM generation can be managed in any suitable manner.

Preferably, lead times are determined for each manufacturing or assembly procedure to be performed to produce the components listed in the BOMs generated above as well as the end product of the BOMs above. Lead time is the time required to assemble or manufacture components into the end product (or higher-level components). For example, lead time can be the time elapsed between the point at which all components for an end product are present and the end of assembly or manufacturing of the end product. These lead times may be compiled per unit of each component/product or may be based on predetermined batch sizes (e.g., 100 units, 1000 units or any other suitable batch size) or any other suitable measurement. For example, lead time for a raw material may be the time elapsed between ordering the material and the material being ready for use in a manufacturing process or any other suitable time amount. Also for example, lead time for a building site may be the time it takes to prepare the site for placement of a building or any other suitable time amount. Similarly, lead time for a building moving device or system can be the time elapsed between the device or system leaving a factory with a building for placement at a building site or other location and the device being ready to move another building or any other suitable time amount.

Preferably, the BOMs, the lead times and estimates of demand for end products are combined to generate at least an initial Master Production Schedule (“MPS”); however, a MPS can be generated in any suitable manner or not at all. Preferably, the MPS details a schedule of assembly and production that enables the manufacturer to meet the estimated demand; however, the MPS can detail any suitable schedule. Further, this schedule preferably addresses only the final level of assembly or production (e.g., resulting in buildings or buildings placed on site) and includes both the timing and quantities of production; however, the schedule can address any suitable level of assembly or production.

In one embodiment, using the MPS as a starting point, it is possible to combine it with the data on lead times and BOMs to derive a schedule of component and/or raw materials requirements to as fine a level of assembly and production detail as is desired. In another embodiment, the MPS, itself, includes the finer level details.

In one embodiment, the schedule accounts for such factors as work-in-progress, current inventory of and pending orders for materials and components, and direct demand for components as service items. From the schedule of requirements, a material replenishment strategy that satisfies these requirements can be determined. In one embodiment, one or more of a wide variety of ordering rules and/or heuristics are incorporated into a computer-maintained Material Requirements Plan (“MRP”) model.

In addition to or instead of the material requirements, other useful data can be generated from the MPS, such as the projected inventory levels for any end product, the projected schedule for any assembly or production process, and the projected utilization of capacity for a particular production operation at any suitable point in time or during any suitable period. In one embodiment, any of the above information is utilized to evaluate current or potential materials replenishment strategies.

Preferably, as the factory system operates, the MRP, MPS and/or BOMs are adjusted in response to changes in forecasts, customers purchases, waste experience or any other suitable factors.

Additional features and advantages are described herein, and will be apparent from, the following Detailed Description and the figures.

### BRIEF DESCRIPTION OF THE FIGURES

FIG. 1 is a block diagram of the influences various components have upon each other in accordance with one embodiment.

FIG. 2 is a block diagram of the relationships various components have with each other in accordance with one embodiment.

FIG. 3 is a block diagram of an inventory and planning system in accordance with one embodiment.

FIG. 4 is a block diagram of the flow of planning and scheduling information amongst and between internal and external portions of an inventory and planning system in accordance with one embodiment.

FIG. 5 is a block diagram of the demand planning information flow in accordance with one embodiment.

FIG. 6 is a block diagram of the sales and operations (S&OP) information flow in accordance with one embodiment.

FIG. 7 is a block diagram of the inventory planning information flow in accordance with one embodiment.

FIG. 8 is a block diagram of the supply chain master schedule information flow in accordance with one embodiment.

FIG. 9 is a block diagram of the flow of allocation planning information in accordance with one embodiment.

FIG. 10 is a block diagram of the flow of collaborative planning information in accordance with one embodiment.

FIG. 11 is a block diagram of an inventory planning system having a learning unit in accordance with one embodiment.

### DETAILED DESCRIPTION

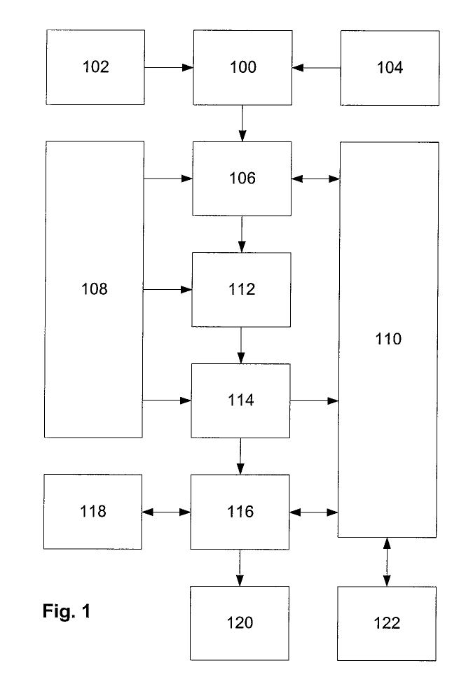

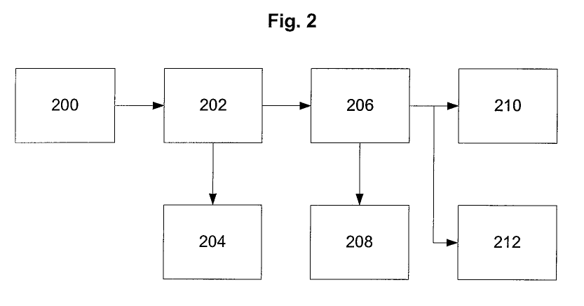

FIGS. 1-2 describe an integrated inventory and planning system for a factory system, which builds large buildings (e.g., buildings legally or physically too large for transportation via public roads, multi-story buildings, single-family homes having a width and length, the smaller of which is greater than 70 feet, townhouses, apartment complexes, commercial buildings, etc.) for transportation substantially intact from one or more construction sites to building sites, in accordance with one or more embodiments. It should be appreciated that the example embodiments described herein are non-limiting, and that any suitable feature of any embodiment can be used with any suitable features of any other embodiments.

Examples of factory systems and/or part of such factory systems with which the integrated inventory and planning system of various embodiments can be used are provided in co-pending U.S. patent application Ser. Nos. 11/431,196 entitled “Building Transport Device” and filed on May 9, 2006; 11/620,103 entitled “Device and Method for Transporting a Load” and filed on Jan. 5, 2007; 11/559,229 entitled “Transport Device Capable of Adjustment to Maintain Load Planarity” and filed on Nov. 13, 2006; 11/620,560 entitled “Method and Apparatus for Mobile Stem Wall” and filed on Jan. 5, 2007, the entire contents of each of which is hereby incorporated by reference. In one embodiment, the system develops and/or maintains a master production schedule based at least in part by any one or more of present, historical and/or projected customer orders/purchases, present, historical and/or projected inventory of raw materials, components and/or complete and/or partly complete buildings, historical, present and/or projected lead times for materials orders, available order quantities, historical, present and/or projected manufacturing requirements (e.g., resources, time, workers, etc.) for complete buildings and/or portions of buildings, historical, present and/or projected building moving equipment availability, historical, present and/or projected prepared building site inventory, historical, present or projected factory system maintenance requirements, or any other suitable data. Preferably, the master production schedule includes one or more periods (e.g., annually, quarterly, monthly, weekly, daily, hourly, or any other suitable time period) during which one or more events or actions (e.g., materials ordering, component or entire building manufacturing, equipment movement, site preparation, or any other suitable event or action) takes place.

Preferably, a bill of materials (BOM) is prepared for each type of building. Alternatively, a BOM can be prepared for each building. A BOM for an item is a list of the components and quantities used to manufacture that item. Preferably, BOMs are also prepared for each of the components listed in the BOM for the building; however, BOMs are not required for each component listed. Further, BOMs are preferably recursively prepared for components listed in other BOMs until only raw materials are listed; however, BOM generation may end at a specified level before reaching raw materials under the assumption that components and/or raw materials beneath that level are available on demand, or BOM generation can be managed in any suitable manner.

Preferably, lead times are determined for each manufacturing or assembly procedure to be performed to produce the components listed in the BOMs generated above as well as the end product of the BOMs above. Lead time is the time required to assemble or manufacture components into the end product (or higher-level components). For example, lead time can be the time elapsed between the point at which all components for an end product are present and the end of assembly or manufacturing of the end product. These lead times may be compiled per unit of each component/product or may be based on predetermined batch sizes (e.g., 100 units, 1000 units or any other suitable batch size) or any other suitable measurement. For example, lead time for a raw material may be the time elapsed between ordering the material and the material being ready for use in a manufacturing process or any other suitable time amount. Also for example, lead time for a building site may be the time it takes to prepare the site for placement of a building or any other suitable time amount. Similarly, lead time for a building moving device or system can be the time elapsed between the device or system leaving a factory with a building for placement at a building site or other location and the device being ready to move another building or any other suitable time amount.

Preferably, the BOMs, the lead times and estimates of demand for end products are combined to generate at least an initial Master Production Schedule (“MPS”); however, a MPS can be generated in any suitable manner or not at all. Preferably, the MPS details a schedule of assembly and production that enables the manufacturer to meet the estimated demand; however, the MPS can detail any suitable schedule. Further, this schedule preferably addresses only the final level of assembly or production (e.g., resulting in buildings or buildings placed on site) and includes both the timing and quantities of production; however, the schedule can address any suitable level of assembly or production.

In one embodiment, using the MPS as a starting point, it is possible to combine it with the data on lead times and BOMs to derive a schedule of component and/or raw materials requirements to as fine a level of assembly and production detail as is desired. In another embodiment, the MPS, itself, includes the finer level details. In one embodiment, the schedule accounts for such factors as work-in-progress, current inventory of and pending orders for materials and components, and direct demand for components as service items. From the schedule of requirements, a material replenishment strategy that satisfies these requirements can be determined. In one embodiment, one or more of a wide variety of ordering rules and/or heuristics are incorporated into a computer-maintained Material Requirements Plan (“MRP”) model.

In addition to or instead of the material requirements, other useful data can be generated from the MPS, such as the projected inventory levels for any end product, the projected schedule for any assembly or production process, and the projected utilization of capacity for a particular production operation at any suitable point in time or during any suitable period. In one embodiment, any of the above information is utilized to evaluate current or potential materials replenishment strategies.

Preferably, as the factory system operates, the MRP, MPS and/or BOMs are adjusted in response to changes in forecasts, customers purchases, waste experience or any other suitable factors. For example, a master schedule 100 can be influenced by customer orders 102 and one or more forecasts 104 (e.g., customer order forecasts, material price forecasts, maintenance schedule forecasts or any other suitable forecasts). In turn, the master schedule 100 influences inventory planning 106. Inventory planning 106 is also influenced by engineering data control information 108 and purchasing, receiving and warehousing information 110. The inventory planning system 106 influences purchasing, receiving and warehousing information 110 as well as manufacturing activity planning 112. Manufacturing activity planning 112 is also influenced by engineering data control information 108. Production planning 114 is influenced by engineering data control information 108 and manufacturing activity planning 112. In turn, production planning 114 influences plan monitoring and control 116 as well as purchasing, receiving and warehousing information 110. Plant monitoring and control 116 is also influenced by purchasing, receiving and warehousing information 110 and plant maintenance 118. In turn, plant monitoring and control influences plant maintenance 118, cost accounting 120 and purchasing, receiving and warehousing information 110. Lastly, purchasing, receiving and warehousing information 110 influences and is influenced by distribution planning 122. It should be noted that in other embodiments, other influence relationships can exist and one or more of the relationships described above can be absent.

For example, distribution planning 200 can be related to the master schedule 202, which is related to rough cut capacity information 204 and material planning 206. Material planning 206 is related to detail capacity 208, procurement 210 and production management 212. Typically the length of a planning cycle for an MRP is related to inventory and supply chain costs, with longer cycles increasing costs; however, the cycle length can have any relationship, including no relationship, with costs.

In one embodiment, one or more suppliers of components and/or raw materials are provided advanced notice of expected future orders. Preferably, the notice is provided automatically, based on projected needs calculated from the above described plans, orders, expectations and experiences; however, notice can be provided in any suitable manner. Preferably, the notice is not binding upon the orderer and merely provides the component and/or material provider the ability to ensure sufficient quantities will be on hand if the order is made; however, the notice can have any suitable nature and/or effect.

Preferably, the system learns from experience such as past errors between projections and actual occurrences for manufacturing waste amount, lead times, customer orders in response to promotions and/or pricing, theft of materials, other loss or any other suitable source of error; however, learning is not required. As a result, the system can provide better projections and planning when presented with similar input in the future. In one embodiment, a learning unit includes a neural network which makes projections based on one or more sets of input data and can be trained based on actual results using any suitable neural network training techniques including, but not limited to, those techniques which inject a noise component into the training data.

In one embodiment, the inventory and planning system automatically provides feedback to marketing entities, enabling the aggressiveness of marketing and/or pricing to depend on current or projected capacity. For example, if the inventory and planning system projects a surplus of finished products above a threshold level, marketing decision makers are automatically notified in any suitable manner (e.g., an e-mail, a report, a memo, an agenda item automatically inserted into a regularly scheduled meeting agenda, etc.). In one embodiment, the notice includes possibilities for reducing the surplus, such as pricing adjustments, promotional efforts, or changes to the finished product (e.g., inclusion of an indoor sauna or appliance) using projections based on previous system experience.

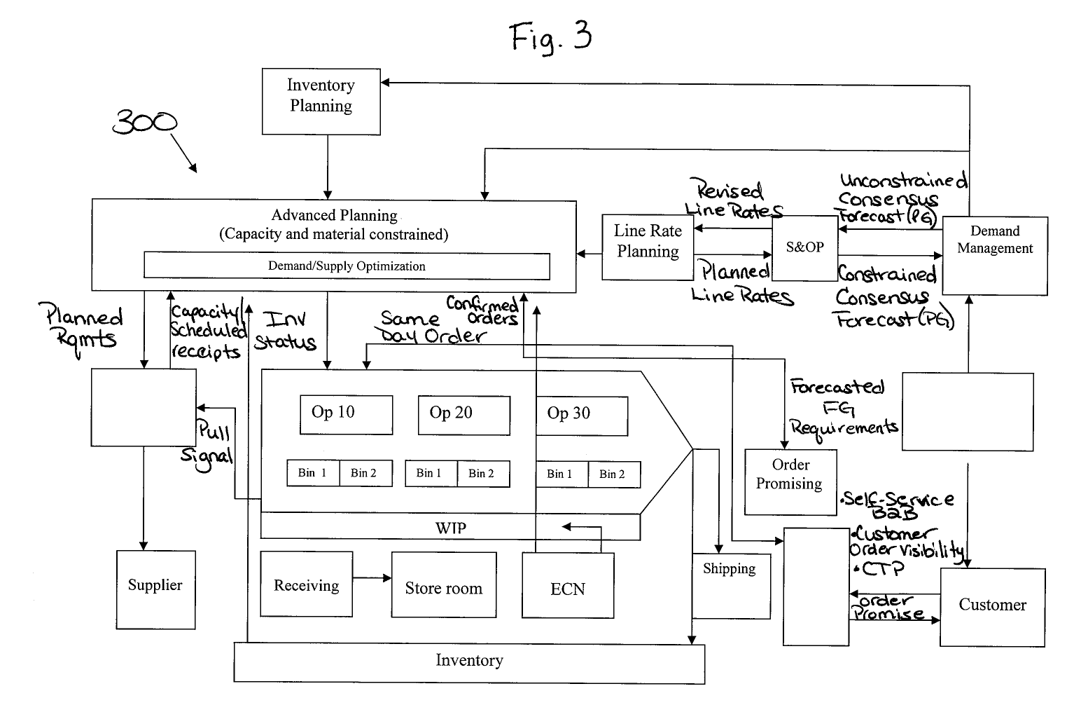

FIG. 3 illustrates an inventory and planning system in accordance with one embodiment. The system 300 implements demand planning by allowing for multiple inputs to the consensus forecasting process and tracking the value/accuracy of the input against actual demand. Further the system has the ability to view and forecast at various levels in the product and market hierarchy with the ability to propagate the forecast to the appropriate detail levels for downstream planning systems.

The system 300 also implements sales and operations planning by enabling what-if analysis around consensus forecasting and the supply/demand matching activities with the consensus output to be directly linked to the downstream planning processes. Further, the system implements inventory planning by taking into account the various facilities within the supply chain and allowing for optimization and what-if analysis around how much and where to keep strategic stocking levels. The system 300 also takes accurate cycle counts by separating store room inventory from floor stock and scrap.

The system 300 also implements master scheduling, production planning, and supplier scheduling & releases by providing real-time visibility to all supply and demand information throughout the supply chain and providing a planning engine that provides visibility and decision support to each supply chain entity, factory and multiple customers. The system 300 also provides inventory synchronization and both master planning and production planning within an integrated system. The system 300 has the ability to conduct rapid what-if scenarios based on the typically changing supply and demand environment through customer and supplier portal integration. Further, the system 300 has the ability to generate and communicate accurate promise dates based upon capacity and materials availability or estimates thereof.

Further, the system 300 provides collaboration by facilitating collaborative planning, forecasting, and replenishment capabilities from the customer, suppliers, and the distributors. The system 300 can integrate portal information directly to the planning systems and processes.

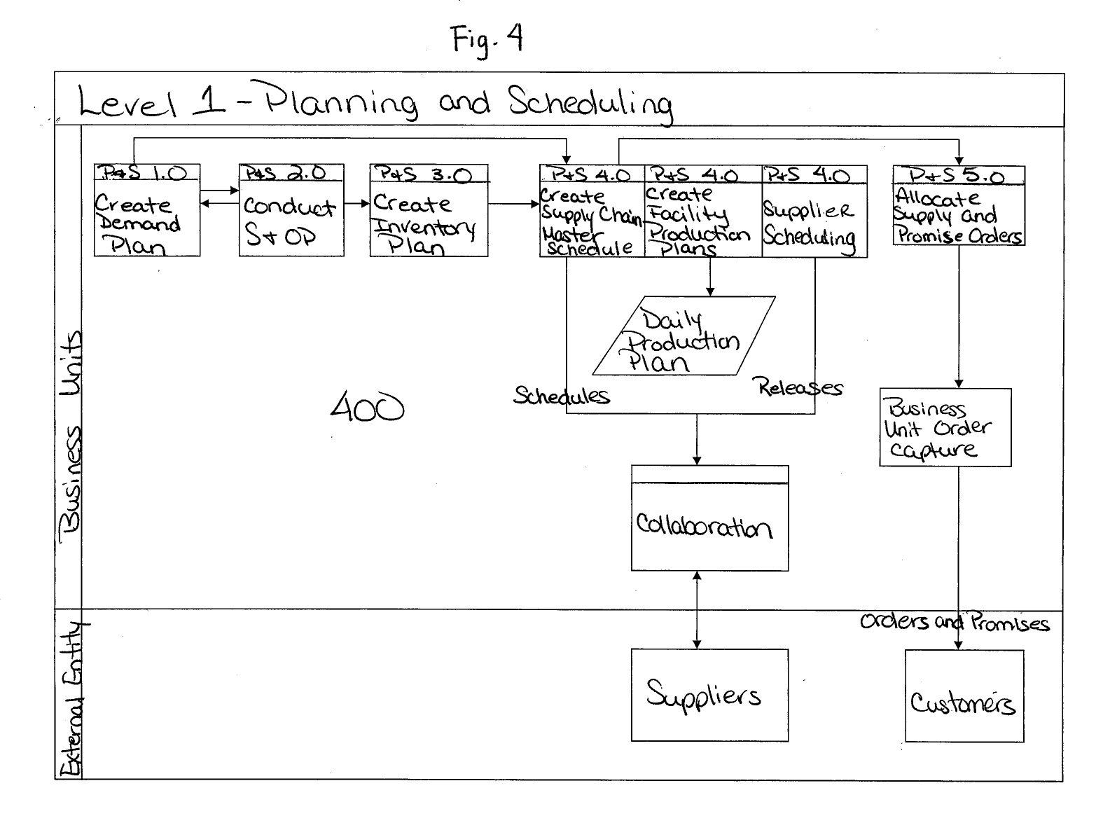

FIG. 4 illustrates the flow of planning and scheduling information amongst and between internal and external portions of an inventory and planning system in accordance with one embodiment. The system 400 includes an efficient and value-adding forecasting process, facilitated by a single user-friendly and web-enabled repository of all demand related information with tools for statistical modeling and manual override of forecasts at any level in the product, sales, or distribution organization. Further, the system 400 includes a single forecasting tool to incorporate multiple demand types, data sources, and functional organizations to enable a collaborative forecasting process. The system 400 also facilitates the improvement of forecast accuracy by better understanding the regular business, the impact of incentives and promotions, trends and product introductions and phase outs.

As a result, the system 400 has improved forecast accuracy resulting in lower safety stock levels being necessary and lower production costs through more accurate forward visibility and production planning as well as reduced expediting costs. The system 400 also enables planners to focus on planning rather than (or perhaps in addition to) reacting because of timely access to information. The system 400 also provides flexibility and improved reaction cycle time, enables measurement of promotion effectiveness and production planning impact as well as collaboration with internal (e.g., sales, operations, finance, etc.) and external (e.g., key customers, all customers, etc.) entities.

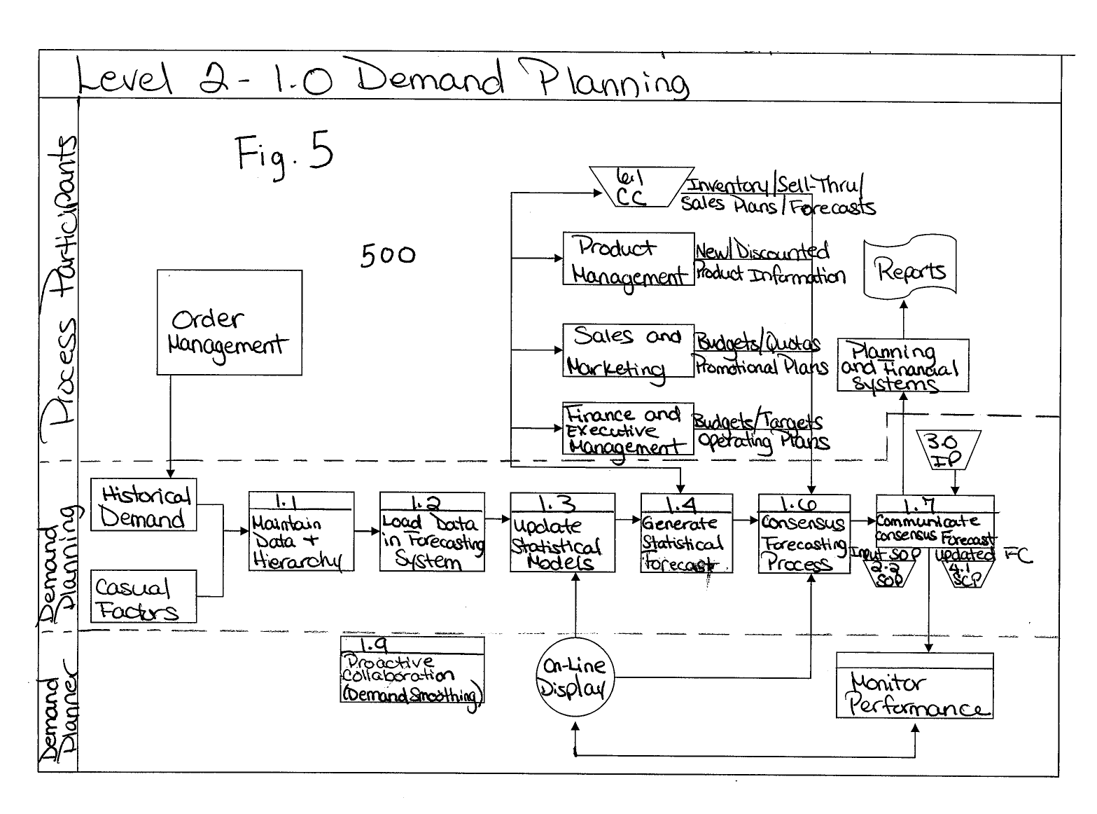

FIG. 5 illustrates the demand planning information flow in accordance with one embodiment. The system 500 enables organizations to produce unconstrained forecasts for future demand from which to generate tactical, operational, and strategic business plans. The system 500 captures and processes information from multiple sources and consolidates demand so that it can be summarized by item, product line, region, time, and organization. The frequency can be monthly, weekly or any other suitable regular or irregular interval of time. Inputs can include sales history, sales plans, and demand forecasts, or any other suitable data. Further, the system enables various entities (e.g., sales, marketing, operations, finance, etc.) in the demand planning process to actively participate.

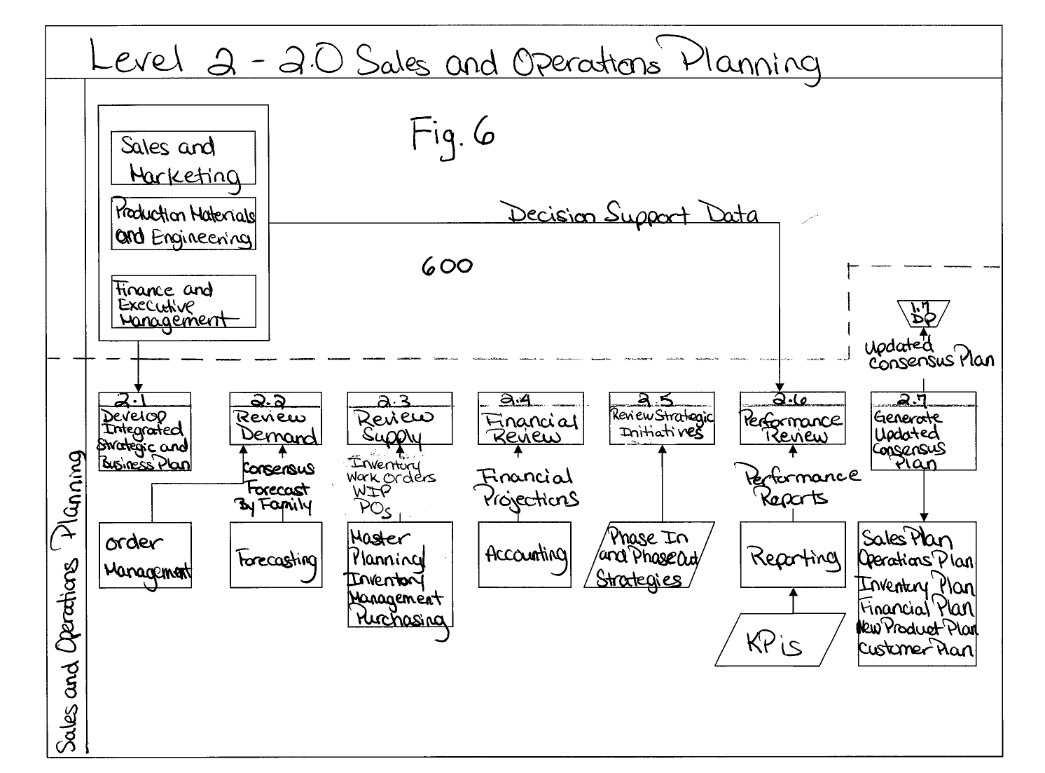

FIG. 6 illustrates the sales and operations (S&OP) information flow in accordance with one embodiment. The system 600 includes a cross function S&OP planning process, driven at the executive level or any other suitable level, to review demand and supply and balance variances where all functions understand their impact on the process including sales, marketing, product management, manufacturing, customer, suppliers, materials management, and product development; however, it is not necessary for all functions to understand their impact in various embodiments.

The system 600 enables what-if analysis around consensus forecasting and the supply/demand matching activities. The S&OP consensus output is directly linked to the downstream planning processes. As a result, the system includes feasible plans that can be executed, reducing downstream re-planning efforts, an improved decision making process with visibility into all information on the current state of the supply chain, a formal structure to facilitate open and proactive communication channels both internally and externally, increased customer service levels by providing flexibility to respond to customer demand and provide better promising information, and reduced costs through improved analysis, communication, integration and consensus on new product introductions and phase out strategies as well as reduced inventory costs.

The system 600 compares the unconstrained consensus forecasts at the product family level against plant specific capabilities and high level materials issues. The result is a plan with a mutually agreed upon line rates for the factory and a constrained consensus forecast and resulting sales, operational and financial plans. The frequency of adjustments to the plan can be once a month or any other suitable regular or irregular time period and can change over time. Inputs can include consensus forecasts, factory capacity, sales plans, financial plans, and supply/demand information or any other suitable information.

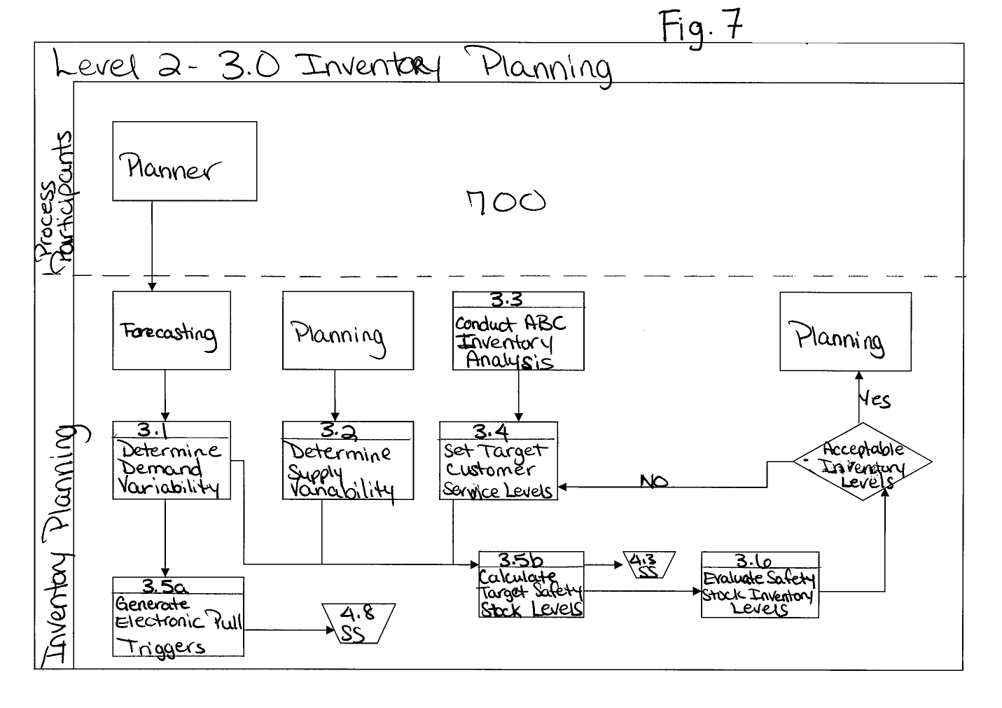

FIG. 7 illustrates the inventory planning information flow in accordance with one embodiment. The system 700 includes an integrated inventory planning solution to establish safety stock levels that is directly linked to the forecast system and allows for what-if analysis around service and inventory levels. The safety stock targets are input to the master plan with exception report performance (e.g., expected variances) against the safety stock targets. The system 700 takes into account supply and demand variability as well as targeted service levels to set targeted safety stock levels throughout the supply chain. The system 700 has real-time visibility into actual inventory. The system 700 also functions with a master planning system that provides horizontal inventory plan visibility and exception reporting against safety stock targets.

The system 700 provides decision support for trade-offs between service levels and inventory resulting in improved control over safety stock, synchronization of inventory levels throughout the supply chain reducing excess inventory, visibility into projected inventory and exception reporting on both excess and short inventory levels, reduced transportation expediting cost by efficiently moving inventory, and reduced manufacturing cost by avoiding unnecessary changeovers.

The system 700 also optimizes the strategic inventory investment decisions by identifying optimal time-phased safety stock levels based on demand and supply variability and targeted service levels. The system 700 facilitates inventory postponement strategies when planning multiple, linked facilities or stations within a facility. The inventory plan can be adjusted monthly, quarterly or at any other suitable regular or irregular frequency. Inputs can include consensus forecasts, demand variability, customer service levels, supplier lead time, and supplier lead time variability or any other suitable data.

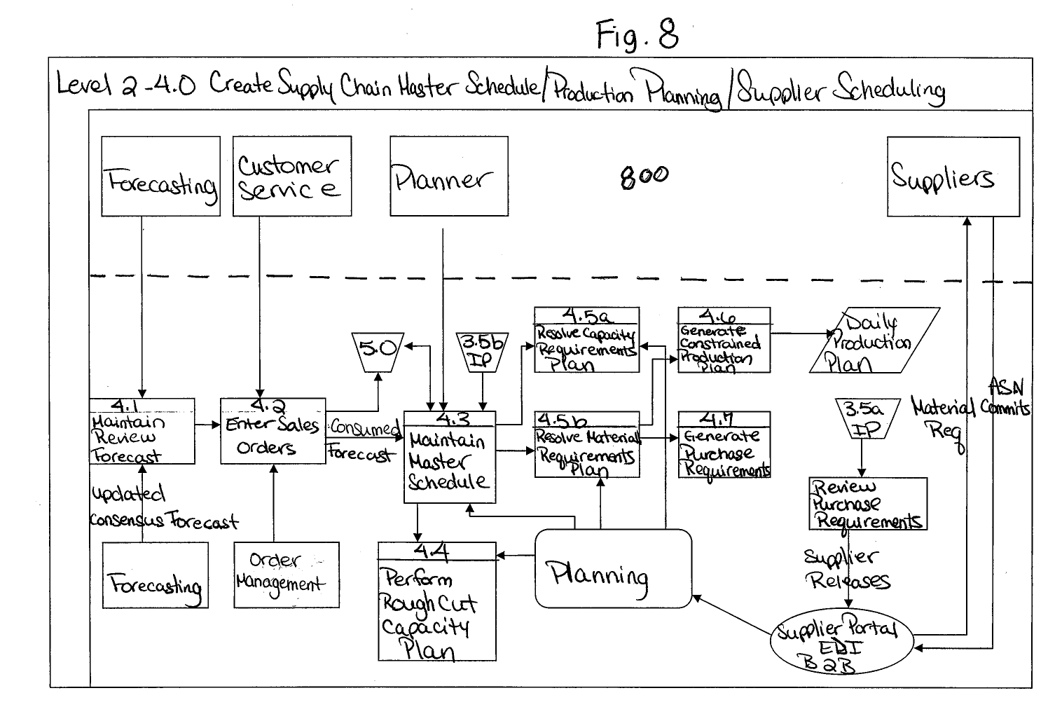

FIG. 8 illustrates the supply chain master schedule information flow in accordance with one embodiment. The system 800 includes enabling planning technologies that rapidly provides visibility to the entire supply chain's capability with respect to existing and incoming demand from materials flow to resource availability. Transactional systems support the collection of accurate data integrated into the planning processes. The system 800 also includes an integrated, iterative planning process and system that provides production planning and re-planning, integrated capacity/materials planning, what-if analysis, and exception based management.

As a result the system 800 includes a planning process that supports exception based management based upon full supply chain visibility, improved levels of customer service in terms of acknowledge dates due to enhanced supply chain visibility and planning capabilities making the system proactive in addition to or instead of reactive, the capability to promise capabilities accurately, increased planner productivity, and improved production plan compliance due to greater visibility in materials and capacity constraints resulting in a smoother build schedule and higher plant efficiency.

The system 800 translates the higher-level aggregate plans into a feasible schedule that can be executed by operations and suppliers. It includes the integrating of demand forecasts and the sales and operation plan into a specific master schedule and creating in a shorter time fence the manufacturing and purchasing orders to support the operations plan. Preferably, master scheduling is adjusted monthly or weekly, production planning is adjusted weekly or daily and supplier releases are adjusted daily; however, any adjustments can be made according to any suitable regular or irregular schedule. Inputs can include consensus forecasts, resources, supply (e.g., inventory, POs, on hand, etc.) or any other suitable data.

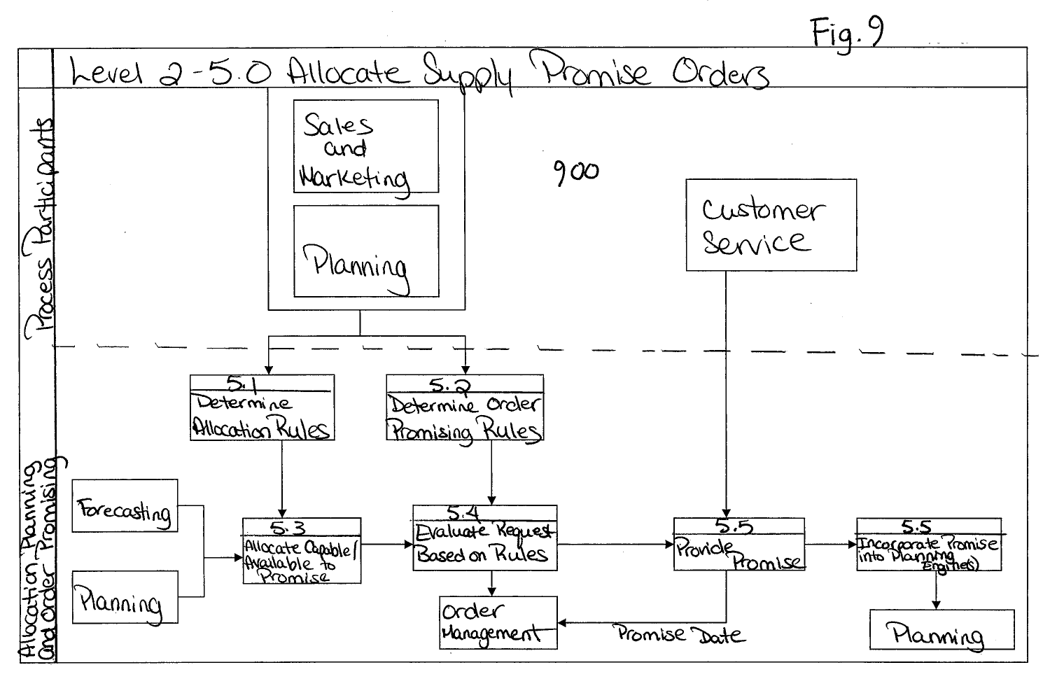

FIG. 9 illustrates the flow of allocation planning information in accordance with one embodiment. The system 900 allocates available capacity and materials based on predetermined rules and promising of actual orders against these capabilities in an automated or semi-automated manner. The allocation can be adjusted daily or on-demand at order promising or at any other suitable frequency. Inputs can include consensus forecasts, demand priorities, material availability, capacity availability, allocation rules, promising rules (e.g., rules used to determine how and when to promise delivery of an item), orders, or any other suitable information.

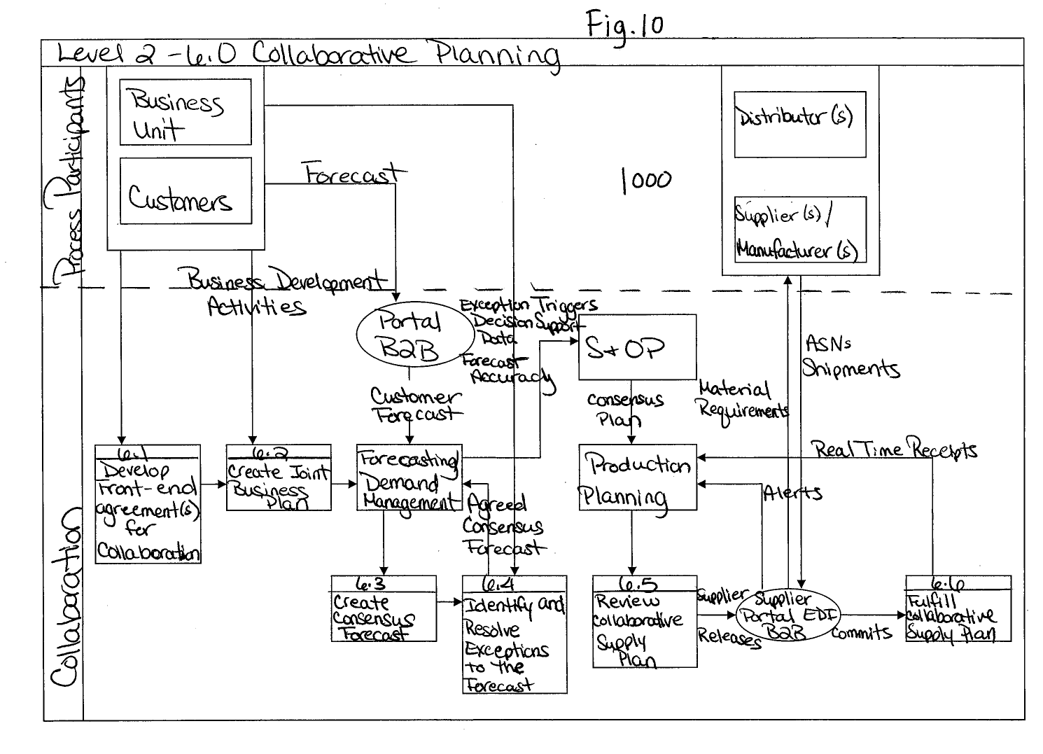

FIG. 10 illustrates the flow of collaborative planning information in accordance with one embodiment. The system 1000 enables collaborative supply planning to determine the timing and quantity of purchases based on rapid visibility of matching of demand and supply. Transactional systems support the collection of accurate data for the procurement processes. Further, the system 1000 implements a collaborative planning, forecasting and replenishment process with the manufacturer's supply base by communicating demand plans (e.g., forecasts) and any change events to proactively resolve demand and supply mismatches and sharing demand and inventory signals between buyers and suppliers to enable efficient replenishment and vendor managed inventory.

As a result, the system 1000 provides improved levels of customer service in terms of acknowledge dates due to enhanced supply chain visibility and planning capabilities, increased planner productivity, reduced raw material/component inventory requirements, decreased expediting costs and procurement administrative costs, decreased stock out/production interruption occurrences and/or reduced supply lead time.

The system 1000 works collaboratively with suppliers and customers by sharing data and costs associated with forecasting, planning and fulfillment. The collaboration plan is adjusted as needed or with any suitable frequency. Inputs can be forecasts, production schedules, capacity, orders, sales plans or any other suitable information.

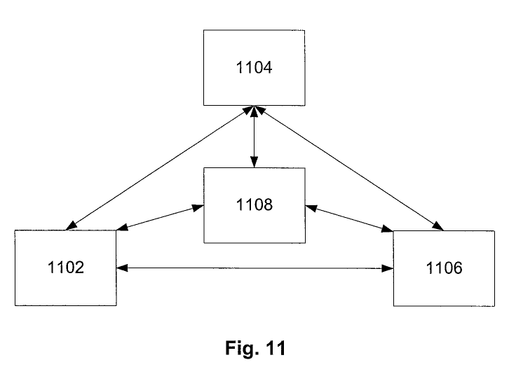

FIG. 11 illustrates an inventory planning system having a learning unit in accordance with one embodiment. The system 1100 includes a demand calculation unit 1102, a requirements calculation unit 1104, a scheduling unit 1106 and a learning unit 1108. Together, the demand calculation unit 1102 together with the requirements calculation unit 1104 calculate a demand for finished products, subcomponents needed to assemble the finished products or other subcomponents, and raw materials needed to assemble the finished product or subcomponents. The scheduling unit 1106 determines an assembly/manufacturing schedule for a factory to follow to make each subcomponent and finished product. The scheduling unit accounts for capacity of various manufacturing/assembly areas of the factory as well as ordering/manufacturing/assembling times. The learning unit 1108 is operable to adjust the calculations of the demand calculation unit 1102, requirements calculation unit 1104, and/or scheduling unit 1106 based on previous experience. For example, waste experienced during the manufacturing/assembly process and any associated delays or additional materials/components requirements can cause the learning unit to adjust up the demand or requirements for subcomponents or raw materials or can adjust the anticipated completion time in the schedule. The learning unit 1108 preferably includes a neural network; however, the learning unit 1108 can include any suitable learning structure and use any suitable learning techniques.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

The invention is claimed as follows:

1. An inventory and planning system comprising:
a demand calculation unit;
a requirements calculation unit; and
a scheduling unit configured to provide a schedule of operation for a factory system producing large buildings for transportation to a substantially permanent building site, wherein the schedule is based at least in part on a first calculation of the demand calculation unit and a second calculation of the requirements calculation unit.

2. The inventory and planning system of claim 1, wherein the demand calculation unit is configured to determine a demand level for a plurality of large buildings.

3. The inventory and planning system of claim 2, wherein the requirements calculation unit is configured to determine a plurality of subcomponents necessary to assemble each of the plurality of large buildings.

4. The inventory and planning system of claim 3, wherein the demand calculation unit and the requirements calculation unit are configured to recursively determine subcomponents and raw materials necessary to assemble each of the plurality of subcomponents necessary to assemble each of the plurality of large buildings until all raw materials necessary for each subcomponent are determined.

5. The inventory and planning system of claim 4, wherein the schedule of operation is determined using a list of the subcomponents and raw materials recursively determined by the demand calculation unit and the requirements calculation unit, production times associated with the subcomponents and raw materials, subcomponent manufacturing capacity and component integration capacity.

6. The inventory and planning system of claim 1, further comprising a learning unit configured to adjust the performance of the demand calculation unit, requirements calculation unit or scheduling unit based upon prior performance results of the factory system.

7. The inventory and planning system of claim 6, wherein the learning unit includes a neural network.

8. An method of operating a factory comprising:
providing a demand calculation unit;
providing a requirements calculation unit; and
providing a scheduling unit configured to provide a schedule of operation for a factory system producing large buildings for transportation to a substantially permanent building site, wherein the schedule is based at least in part on a first calculation of the demand calculation unit and a second calculation of the requirements calculation unit.

9. The method of claim 8, wherein the demand calculation unit determines a demand level for a plurality of large buildings.

10. The method of claim 9, wherein the requirements calculation unit determines a plurality of subcomponents necessary to assemble each of the plurality of large buildings.

11. The method of claim 10, wherein the demand calculation unit and the requirements calculation unit recursively determine subcomponents and raw materials necessary to assemble each of the plurality of subcomponents necessary to assemble each of the plurality of large buildings until all raw materials necessary for each subcomponent are determined.

12. The method of claim 11, wherein the schedule of operation is determined using a list of the subcomponents and raw materials recursively determined by the demand calculation unit and the requirements calculation unit, production times associated with the subcomponents and raw materials, subcomponent manufacturing capacity and component integration capacity.

13. The method of claim 8, further comprising adjusting the performance of the demand calculation unit, requirements calculation unit or scheduling unit based upon prior performance results of the factory system.

14. The method of claim 13, wherein the performance is adjusted using a neural network.

15. A computer program product comprising:
a computer usable medium having computer readable program code embodied therein configured to perform inventory planning, said computer program product comprising:
computer readable code configured to cause a computer to calculate demand;
computer readable code configured to cause a computer to calculate requirements; and
computer readable code configured to cause a computer to determine a schedule of operation for a factory system producing large buildings for transportation to a substantially permanent building site, wherein the schedule is based at least in part on a first calculation of the computer readable code configured to cause a computer to calculate demand and a second calculation of the computer readable code configured to cause a computer to calculate requirements.

16. The computer program product of claim 15, wherein the computer readable code configured to cause a computer to calculate demand includes computer readable code configured to cause a computer to determine a demand level for a plurality of large buildings.

17. The computer program product of claim 16, wherein the computer readable code configured to cause a computer to calculate requirements includes computer readable code configured to cause a computer to determine a plurality of subcomponents necessary to assemble each of the plurality of large buildings.

18. The computer program product of claim 10, wherein the computer readable code configured to cause a computer to calculate demand and the computer readable code configured to cause a computer to calculate requirements recursively determine subcomponents and raw materials necessary to assemble each of the plurality of subcomponents necessary to assemble each of the plurality of large buildings until all raw materials necessary for each subcomponent are determined.

19. The computer program product of claim 18, wherein the schedule of operation is determined using a list of the subcomponents and raw materials recursively determined by the computer readable code configured to cause a computer to calculate demand and the computer readable code configured to cause a computer to calculate requirements, production times associated with the subcomponents and raw materials, subcomponent manufacturing capacity and component integration capacity.

20. The computer program product of claim 15, further comprising computer readable code configured to cause a computer to adjusting the performance of the computer readable code configured to cause a computer to calculate demand, computer readable code configured to cause a computer to calculate requirements or computer readable code configured to cause a computer to determine a schedule of operation based upon prior performance results of the factory system using a neural network.
